(19) United States
(12) Patent Application Publication
(10) Pub. No.: US 2009/0295984 A1
(43) Pub. Date: Dec. 3, 2009

(54) Image pickup apparatus

(75) Inventors: Yukinobu Kawai, Aichi (JP); Kimihiro Abe, Aichi (JP); Katsuhisa Hakoda, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/387,734

(22) Filed: May 7, 2009

(30) Foreign Application Priority Data
May 8, 2008 (JP) P2008-122477

(51) Int. Cl. H04N 5/225

(52) U.S. Cl. 348/373; 348/E05.024

(57) ABSTRACT

An image pickup apparatus includes an operation button; and an operation member turnably mounted around the operation button, having an operation portion, and configured to allow a user to select a plurality of operation states by turning the operation portion. The operation portion is formed such that a user's finger placed on the operation button comes into contact with the operation portion at one or more positions to which the operation portion is turned.

The present application claims priority from Japanese Patent Application No. JP 2008-122477 filed in the Japanese Patent Office on May 8, 2008, the entire content of which is incorporated herein by reference.

### BACKGROUND OF THE INVENTION

1. Field of the Invention

The present invention relates to image pickup apparatuses, and particularly to an image pickup apparatus including an operation button and an operation member for changing an operation mode.

2. Description of the Related Art

Image pickup apparatuses, such as digital still cameras, having a shutter button for picking up still images and a zoom lever for zoom operation have been widely available. Typically, a zoom lever has two zoom switches for telephoto and wide-angle modes and an operation lever located between the two zoom switches. When the user operates the operation lever, one of the two zoom switches for telephoto and wide-angle modes is operated.

Some of the image pickup apparatuses of the above-described type provide a moving-image pickup mode for recording moving images and a still-image pickup mode for recording still images. Switching between these modes can be done, for example, by switching operation of a selection switch included in an apparatus main body or by changing operation performed on a mode setting screen displayed on a monitor or the like.

However, to check or change the current mode of the image pickup apparatus, the user has to visually check the current state of the selection switch or the current mode status displayed on the setting screen or monitor. Moreover, during image pickup or during travel in a non-image-pickup mode, if the selection switch comes into contact with an external object and the current mode is changed, the user may fail to notice the mode change. Then, for example, when the user visually checks a finder or monitor for image pickup and realizes that it is necessary to set the mode again, the user is unable to immediately start the image pickup operation.

A digital still camera such as that described above is disclosed, for example, in Japanese Unexamined Patent Application Publication No. 2007-180672 and Japanese Unexamined Patent Application Publication No. 2007-108338 (corresponding to US Patent Publication No. 2007-081820 A1).

### SUMMARY OF THE INVENTION

It is desirable to provide an image pickup apparatus that is capable of allowing the user to immediately sense a setting state of a main body of the apparatus.

To solve the problems described above, an image pickup apparatus according to an embodiment of the present invention includes an operation button; and an operation member turnably mounted around the operation button, having an operation portion, and configured to allow a user to select a plurality of operation states by turning the operation portion. The operation portion is formed such that a user's finger placed on the operation button comes into contact with the operation portion at one or more positions to which the operation portion is turned.

In the image pickup apparatus according to an embodiment of the present invention, the user touching the operation button touches the operation portion of the operation member at the same time. This allows the user to sense that the operation member is currently located at a switching position corresponding to a predetermined operation state. That is, the image pickup apparatus allows the user to immediately sense that the apparatus is in a predetermined operation state.

### BRIEF DESCRIPTION OF THE DRAWINGS

FIG. 1 is a perspective view illustrating an image pickup apparatus to which the present invention is applied.

FIG. 2 is an exploded perspective view of the image pickup apparatus illustrated in FIG. 1.

FIG. 3 is a rear view of the image pickup apparatus illustrated in FIG. 1.

FIG. 4A is an overall plan view of the image pickup apparatus illustrated in FIG. 1; FIG. 4B is a front view of an upper part of the image pickup apparatus illustrated in FIG. 1; and FIG. 4C is a right side view of the upper part illustrated in FIG. 4B.

FIG. 5 is an exploded perspective view of an operation unit.

FIG. 6 is a perspective view illustrating a shutter button and a zoom lever.

FIG. 7 is a perspective view illustrating a mode switching lever.

FIG. 8 is a plan view illustrating the mode switching lever turned to a switching position outside an apparatus main body.

FIG. 9 is a plan view illustrating the mode switching lever turned to a switching position inside the apparatus main body.

FIG. 10 is a perspective view illustrating a zoom switch operated by the zoom lever and a zoom operation ring.

FIG. 11A is a plan view of the zoom switch operated by the zoom lever and the zoom operation ring and illustrates a state in which a switch piece is tilted in one direction; FIG. 11B illustrates a state in which the switch piece of FIG. 11A is located at a neutral position; and FIG. 11C illustrates a state in which the switch piece of FIG. 11A is tilted in the other direction.

FIG. 12 is a perspective view illustrating another example of a mode switching lever.

### DESCRIPTION OF THE PREFERRED EMBODIMENTS

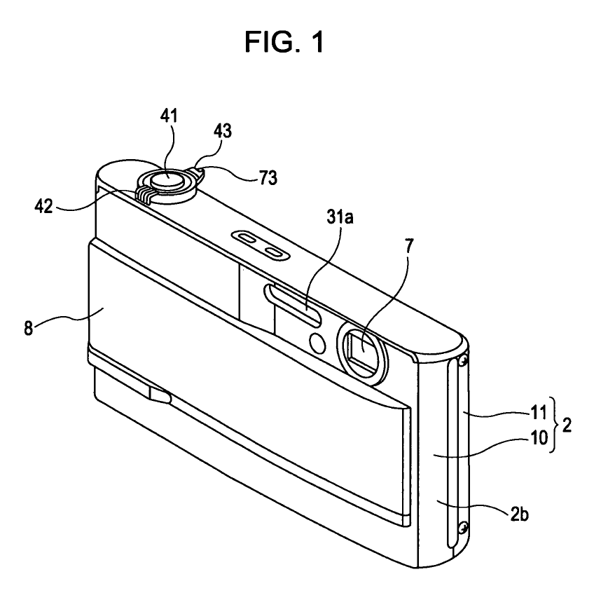

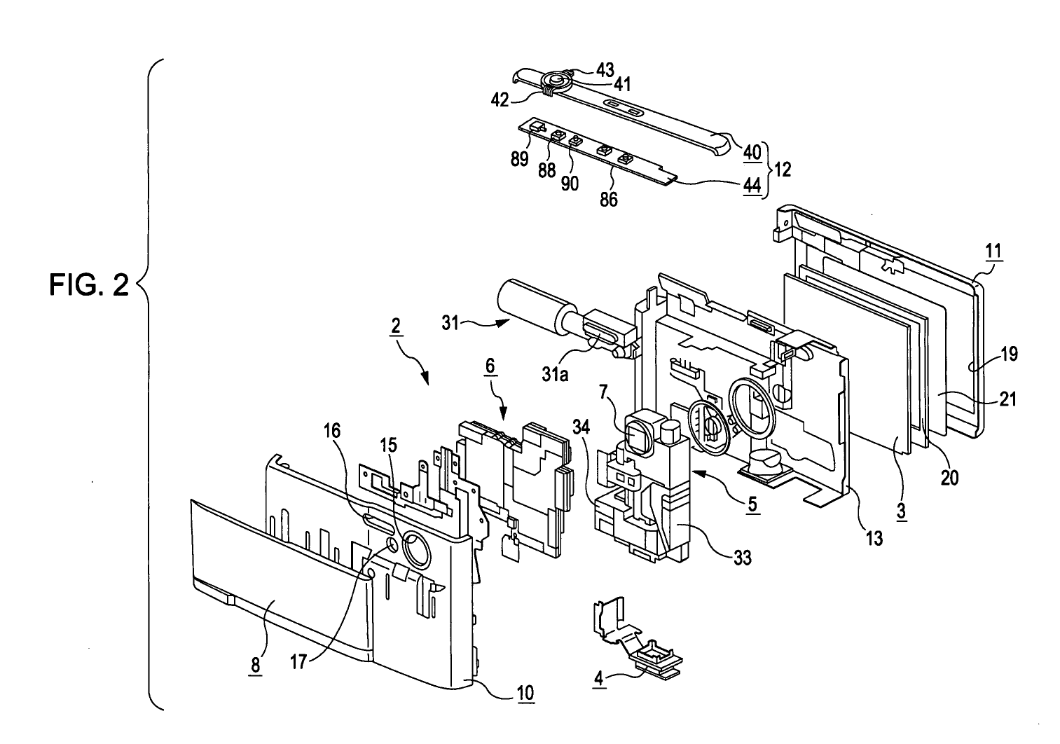

Hereinafter, an image pickup apparatus to which the present invention is applied will be described in detail with reference to the drawings. Referring to FIG. 1 and FIG. 2, an image pickup apparatus 1 to which the present invention is applied is a digital still camera capable of picking up still and moving images. The image pickup apparatus 1 includes an apparatus main body 2 having a substantially rectangular shape, a lens device 5, a display panel 3, a control device 6, a lens cover 8, and a battery power supply (not shown). The lens device 5 picks up a subject image as light, and guides the light to an image pickup element 4, such as a charge-coupled device (CCD) sensor or a complementary metal oxide semiconductor (CMOS) sensor. The display panel 3 includes a liquid crystal display capable of displaying images on the basis of video signals output from the image pickup element 4. The control device 6 controls operation of the lens device 5 and display of the display panel 3. The lens cover 8 opens and closes an image pickup lens 7 facing toward the front of the apparatus main body 2.

The apparatus main body 2 includes a front case 10 and a rear case 11 disposed on top of each other in the front-to-rear direction, an operation unit 12 disposed at the top of the apparatus main body 2 and including a shutter button and a zoom lever, and a main frame 13 partitioning a space defined by the front case 10 and the rear case 11 into front and rear parts. The lens cover 8 is vertically slidably attached to the front side of the front case 10.

The front case 10 is made of metal, such as stainless steel, or resin, such as engineering plastic, and has a substantially rectangular shape. A principal surface of the front case 10, the principal surface constituting the front side of the apparatus main body 2, is provided with a lens hole 15 allowing the image pickup lens 7 to be exposed, a flash hole 16 allowing a light emitting part 31a of a flash device 31 to be exposed, and an opening 17 allowing light emitting and detecting (receiving) parts of an auto-focus mechanism to be exposed. The lens cover 8 is vertically movably attached to the front case 10. The lens cover 8 protects the lens hole 15, the flash hole 16, and the opening 17 while the image pickup apparatus 1 is not in use.

The lens cover 8 is slidably supported between an open position at which the image pickup lens 7 etc. are open and a closed position at which the image pickup lens 7 etc. are closed. The lens cover 8 is biased in the sliding direction by a biasing member, such as a toggle spring. In the image pickup apparatus 1, sliding the lens cover 8 to the open position turns on the drive power of the apparatus main body 2, and sliding the lens cover 8 to the closed position turns off the drive power of the apparatus main body 2.

The rear case 11 is made of metal, such as stainless steel, or resin, such as engineering plastic, and has a substantially rectangular shape. The rear case 11 is provided with a rectangular opening window 19 allowing a display surface of the display panel 3, serving as a display device, to be exposed. The opening window 19 is wide open on the back side of the rear case 11. The display panel 3 is disposed inside the opening window 19. The display panel 3 is constituted by a unit in which the liquid crystal display having a size corresponding to the size of the opening window 19 is connected to a backlight disposed on the inner surface of the liquid crystal display. A protection plate 21 is disposed on the display surface of the display panel 3, with a sealing frame 20 interposed therebetween. The outer periphery of the protection plate 21 is in contact with an inner surface around the opening window 19.

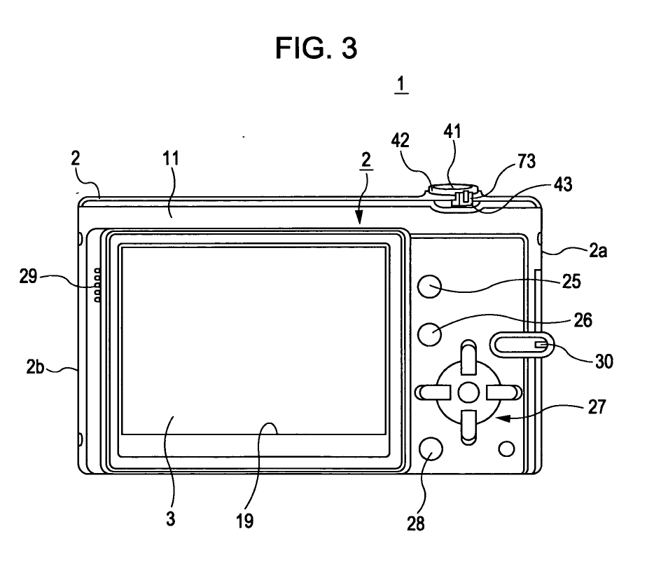

As illustrated in FIG. 3, the rear case 11 is provided with various operation switches. The operation switches include a screen display button 25, a menu button 26, direction keys 27, and a screen button 28, which are arranged at appropriate positions. The screen display button 25 is used to display a screen. The menu button 26 is used to select various menus. The direction keys 27 are used to move a cursor or the like for selection of menu items. The screen button 28 is used to change the screen size or clear the screen. Speaker holes 29 are open at an end of the rear case 11, the end being adjacent to the display panel 3. A speaker is disposed inside the speaker holes 29. A metal support 30 for a strap is attached to an end of the rear case 11, the end being opposite the speaker holes 29.

The lens device 5 is mounted to one side of the front surface of the main frame 13, with the image pickup element 4 positioned at the bottom of the lens device 5 and the optical axis of the lens device 5 oriented vertically. The flash device 31 and the control device 6 are attached to the main frame 13. The control device 6 is formed by mounting a microcomputer, resistors, capacitors, and other electronic components on a wiring board.

The lens device 5 includes a lens barrel 33, the image pickup element 4 secured to the lens barrel 33, and an image-blur correcting unit 34 mounted to the lens barrel 33. The lens barrel 33 securely holds or movably supports each lens of a lens system having lens groups, each including a plurality of lenses arranged on the same optical axis. The image pickup element 4 is, for example, a CCD or a CMOS on the optical axis of the lens system. The image-blur correcting unit 34 corrects image blur in the lens system.

Next, the operation unit 12 including a shutter button and a zoom lever will be described. As illustrated in FIG. 2 to FIG. 5, the operation unit 12 is positioned at the top of the apparatus main body 2 by being supported by and between the front case 10 and the rear case 11. The operation unit 12 includes an upper surface plate 40 constituting the upper surface of the apparatus main body 2, a shutter button 41 positioned in a manner biased toward the right side of the upper surface plate 40, a zoom lever 42 turnably mounted around the shutter button 41, a mode switching lever 43 turnably mounted around the shutter button 41 and used to switch the mode of the apparatus main body 2, and a switch plate 44 provided with various switches operated by the shutter button 41, the zoom lever 42, and the mode switching lever 43.

The shutter button 41, the zoom lever 42, and the mode switching lever 43 in the operation unit 12 are positioned in a manner biased toward a right side 2a of the apparatus main body 2. Therefore, during image pickup, the shutter button 41 is pressed and the zoom lever 42 and the mode switching lever 43 are turned with an index finger of the user holding the apparatus main body 2. The shutter button 41, the zoom lever 42, and the mode switching lever 43 are grouped together in one place. This allows the user to continuously perform such operations as mode switching, zoom operation, and shutter operation. Thus, it is possible to realize a smooth image pickup operation.

The upper surface plate 40 is made of resin, such as engineering plastic, and has a substantially rectangular plate-like shape. The upper surface plate 40 is supported by and between the front case 10 and the rear case 11 to constitute the upper surface of the apparatus main body 2. The upper surface plate 40 has engaging grooves 50 on both sides thereof in the longitudinal direction. The front case 10 and the rear case 11 are engaged with the corresponding engaging grooves 50.

The upper surface plate 40 has a mounting hole 51 in which the shutter button 41 and the zoom lever 42 are mounted. An upper guide wall 52, a lower guide wall 53, and an insertion hole 54 are formed in the mounting hole 51. The zoom lever 42 and the mode switching lever 43 are fitted to the upper guide wall 52 and the lower guide wall 53, respectively. The shutter button 41 and the zoom lever 42 are inserted into the insertion hole 54.

The upper guide wall 52 rises into an arc shape and guides turning of the zoom lever 42. The zoom lever 42 is fitted to the upper guide wall 52 from above, and is guided by and turned along the upper guide wall 52. Similarly, the lower guide wall 53 rises into an arc shape and guides turning of the mode switching lever 43. The mode switching lever 43 is fitted to the lower guide wall 53 from below, and is guided by and turned along the lower guide wall 53. The insertion hole 54 is a through hole provided at substantially the center of the mounting hole 51. The shutter button 41 and the zoom lever 42 are inserted into the insertion hole 54.

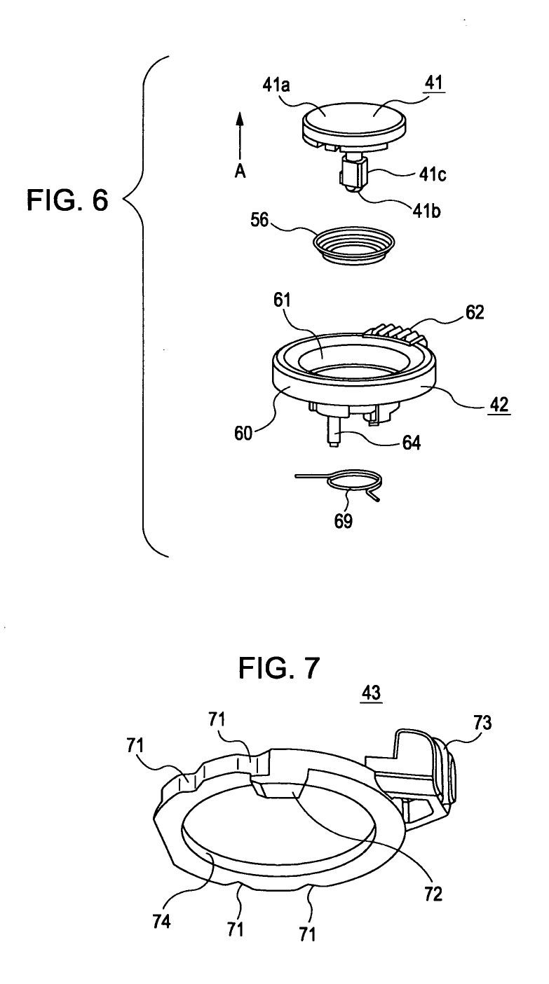

The shutter button 41 is vertically movably mounted inside a recessed portion 61 formed at the center of the zoom lever 42. As illustrated in FIG. 6, the shutter button 41 includes a disk-like pressed portion 41a and a pressing shaft 41b. The pressing shaft 41b is inserted into the insertion hole 54 and presses a release switch 88 on the switch plate 44. The pressed portion 41a is pressed, for example, with an index finger of the user for image pickup. The pressed portion 41a is exposed from the upper surface of the apparatus main body 2. The pressing shaft 41b protrudes on the back side of the pressed portion 41a. When the pressed portion 41a is mounted in the recessed portion 61, the tip of the pressing shaft 41b faces the release switch 88 on the switch plate 44 attached to the back side of the upper surface plate 40.

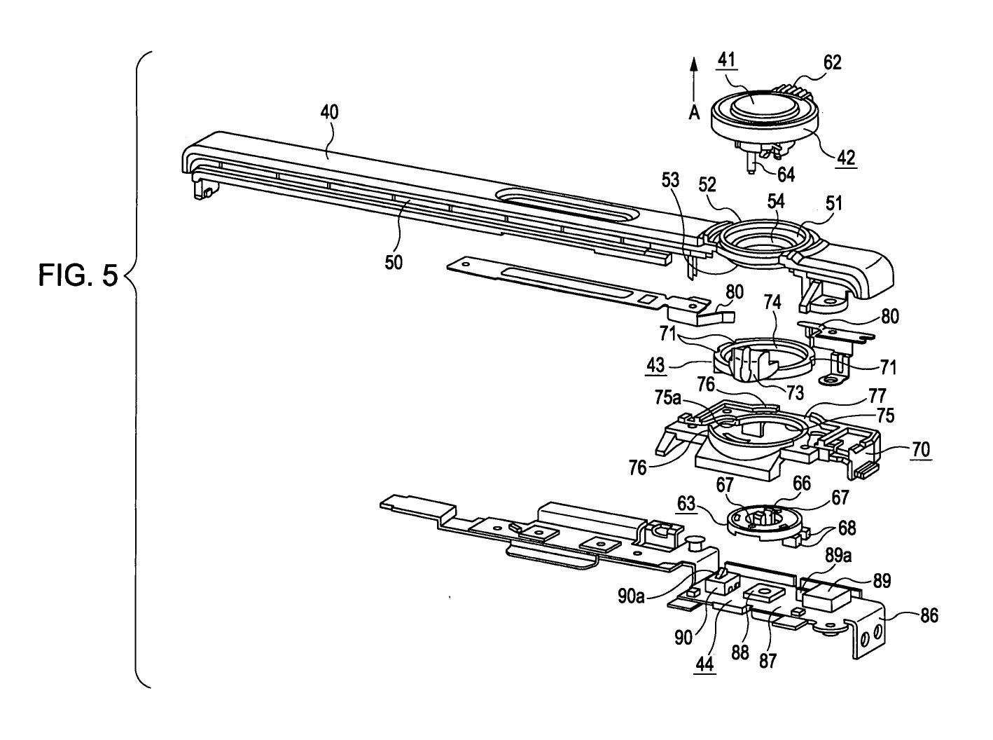

One end of a spring 56 is in contact with the back side of the pressed portion 41a. The other end of the spring 56 is secured to a locking step portion (not shown) formed inside the recessed portion 61 of the zoom lever 42. Thus, the pressing shaft 41b of the shutter button 41 is continuously biased in the direction of arrow A (see FIG. 5 and FIG. 6) away from the release switch 88, so that the tip of the pressing shaft 41b is separated from the release switch 88. When the pressed portion 41a of the shutter button 41 is pressed by the user, the tip of the pressing shaft 41b presses the release switch 88.

The pressing shaft 41b of the shutter button 41 is provided with a retaining portion 41c. The retaining portion 41c is formed at substantially the center in the longitudinal direction of the pressing shaft 41b. The retaining portion 41c bulges out in a direction perpendicular to the longitudinal direction of the pressing shaft 41b. After the pressing shaft 41b is inserted into a shaft hole (not shown) that is made inside the recessed portion 61 of the zoom lever 42 to fit the shape of the retaining portion 41c, the shutter button 41 is turned to displace the retaining portion 41c from the shaft hole. This can prevent the pressing shaft 41b from slipping off through the shaft hole. Thus, the shutter button 41 becomes vertically movable within the recessed portion 61 by a distance between the back side of the pressed portion 41a and the retaining portion 41c. Since the retaining portion 41c is fitted into a zoom operation ring 63 (described below), turning of the retaining portion 41c relative to the zoom lever 42 is restricted. This can prevent the shutter button 41 from turning and slipping off through the shaft hole.

The zoom lever 42 drives zoom lens groups of the lens device 5 in the telephoto or wide-angle direction. The zoom lever 42 is connected, through the zoom operation ring 63, to a zoom switch 89 mounted on the switch plate 44. The zoom lever 42 is turnably attached to the mounting hole 51 in the upper surface plate 40. The zoom lever 42 operates the zoom switch 89 in the telephoto or wide-angle direction depending on the turning direction.

The zoom lever 42 includes a disk-like lever main body 60 greater in diameter than the shutter button 41, and the recessed portion 61 formed at the center of the lever main body 60 and to which the shutter button 41 is mounted. The lever main body 60 is provided with a fitting groove fitted to the upper guide wall 52 in the mounting hole 51 of the upper surface plate 40. The lever main body 60 is guided and turnably supported by the upper guide wall 52. The lever main body 60 is provided with a zoom operation knob 62 to be operated by the user. The zoom operation knob 62 is formed on part of the outer periphery of the lever main body 60. The zoom operation knob 62 is a knurled knob laterally protruding from the lever main body 60.

The recessed portion 61 formed at substantially the center of the lever main body 60 is a circular recess slightly greater in diameter than the shutter button 41. The locking step portion to which one end of the spring 56 is secured and the shaft hole into which the pressing shaft 41b and the retaining portion 41c are inserted are formed at the bottom of the recessed portion 61. The shaft hole has the same rectangular shape as the retaining portion 41c on the pressing shaft 41b of the shutter button 41. After the retaining portion 41c is fit to the shape of the shaft hole and inserted into the shaft hole, the shutter button 41 is turned. This can prevent the shutter button 41 from slipping off through shaft hole.

The lever main body 60 is connected to the zoom operation ring 63 disposed on the lower surface side of the upper surface plate 40. The zoom operation ring 63 is engaged with the zoom switch 89 mounted on the switch plate 44. Turning the lever main body 60 causes the zoom switch 89 to tilt in the telephoto or wide-angle direction. A plurality of connecting shafts 64 to be inserted into the zoom operation ring 63 is vertically arranged on the lower surface of the lever main body 60.

The zoom operation ring 63 is an annular member made of synthetic resin, metal, or the like. A support hole 66 for supporting the pressing shaft 41b inserted into the recessed portion 61 of the zoom lever 42 is formed at substantially the center of the zoom operation ring 63. The support hole 66 is a substantially rectangular hole into which the retaining portion 41c on the pressing shaft 41b can be inserted. The support hole 66 restricts turning of the shutter button 41 by slidably supporting the periphery of the retaining portion 41c. The tip of the pressing shaft 41b inserted into the support hole 66 faces the release switch 88 on the switch plate 44.

The zoom operation ring 63 is provided with a plurality of connecting holes 67 in its principal surface having the support hole 66. The connecting shafts 64 vertically arranged on the lower surface of the lever main body 60 are inserted into the corresponding connecting holes 67. When the zoom lever 42 to which the shutter button 41 is mounted is inserted into the mounting hole 51 in the upper surface plate 40, the connecting shafts 64 are inserted into the connecting holes 67. Then, the zoom operation ring 63 and the zoom lever 42 are, for example, securely swaged together. Since the zoom lever 42 is integral with the zoom operation ring 63 via the upper surface plate 40 and a cover plate 70, the zoom lever 42 is prevented from slipping off through the mounting hole 51.

Engaging pieces 68 to be engaged with a switch piece 89a of the zoom switch 89 are formed on the lower surface of the zoom operation ring 63. The engaging pieces 68 are formed in pair, with a predetermined distance therebetween. The pair of engaging pieces 68 protrudes outward to support the switch piece 89a on both sides. When the zoom operation ring 63 is turned in response to turning of the zoom lever 42, one of the engaging pieces 68 comes into contact with the switch piece 89a depending on the turning direction. Thus, the switch piece 89a is tilted in the telephoto or wide-angle direction.

A torsional coil spring 69 is secured to the lower surface of the zoom lever 42. Thus, the turning position of the zoom lever 42 is continuously restricted to a neutral position at which the switch piece 89a of the zoom switch 89 is not tilted. When the lever main body 60 of the zoom lever 42 is turned by the user in one or the other direction against the biasing force of the torsional coil spring 69, the switch piece 89a is tilted in the telephoto or wide-angle direction. Upon completion of the user's turning operation, the lever main body 60 is turned back to the neutral position. Thus, the operation of the zoom switch 89 ends.

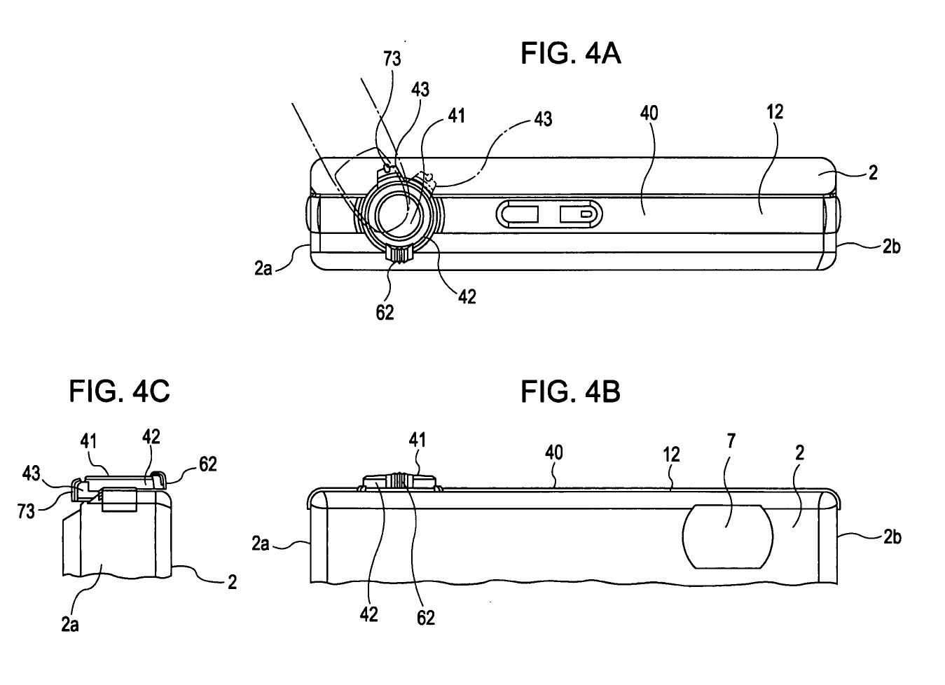

As illustrated in FIGS. 4A to 4C, the zoom lever 42 is supported on the upper surface plate 40 and allows the zoom operation knob 62 to protrude toward the front of the apparatus main body 2. Therefore, the zoom operation knob 62 of the zoom lever 42 can be operable with the cushion of an index finger of the user holding the apparatus main body 2. Thus, the user can continuously perform zoom and shutter operations.

The mode switching lever 43 selects functional modes, such as a still-image pickup mode, a moving-image pickup mode, and a playback mode. The mode switching lever 43 is turnably supported by and between the upper surface plate 40 and the cover plate 70 attached to the lower surface of the upper surface plate 40. The mode switching lever 43 is an annular member having substantially the same diameter as that of the zoom lever 42. The mode switching lever 43 is supported under the mounting hole 51 of the upper surface plate 40 and thus is disposed under the zoom lever 42. The inner periphery of the mode switching lever 43 is supported by the lower guide wall 53 vertically disposed under the mounting hole 51 in the upper surface plate 40, while the outer periphery of the mode switching lever 43 is partially supported by the cover plate 70. Thus, turning of the mode switching lever 43 is guided.

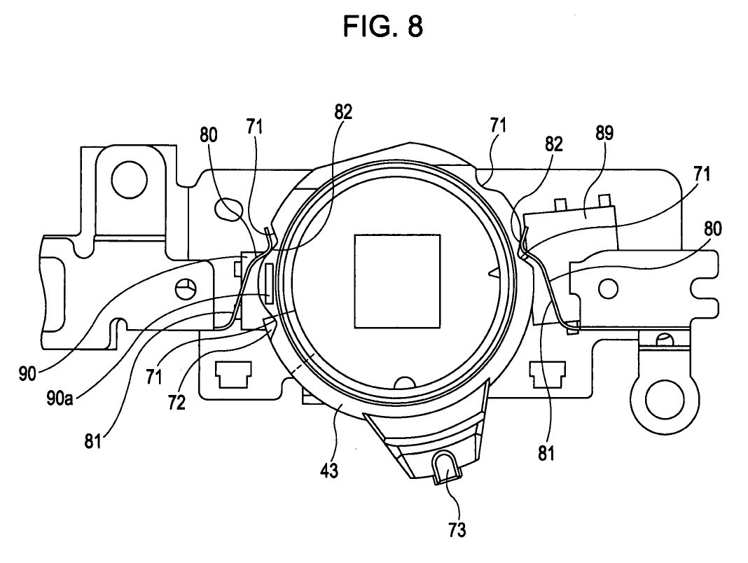

As illustrated in FIG. 7, depending on the number of functional modes, a plurality of positioning notches 71 for restricting the turning position of the mode switching lever 43 are formed in the outer periphery of the mode switching lever 43. The positioning notches 71 are formed by making substantially V-shaped cuts in the outer periphery of the mode switching lever 43. Each of positioning members 80 (described below) is engageably and disengageably fitted into each of the positioning notches 71. Thus, the turning position of the mode switching lever 43 is restricted to positions at which the positioning members 80 are fitted into the positioning notches 71. Functional modes, each corresponding to one turning position, can thus be selected. As illustrated in FIG. 8, in the present embodiment, two positioning notches 71 are formed in each of opposite parts of the outer periphery of the mode switching lever 43. Thus, two different modes are selectable when the positioning members 80 are fitted into positioning notches 71.

A pressing piece 72 that presses a mode selection switch 90 mounted on the switch plate 44 protrudes from the lower surface of the mode switching lever 43. The pressing piece 72 is formed so as to be able to come into and out of contact with the mode selection switch 90 positioned on the turning locus of the mode switching lever 43, whose turning position is restricted. According to the turning of the mode switching lever 43, the pressing piece 72 presses or releases a switch piece 90a of the mode selection switch 90.

A mode selection knob 73 operated by the user to turn the mode switching lever 43 is formed on part of the outer periphery of the mode switching lever 43. The mode selection knob 73 is a substantially L-shaped knob protruding laterally from the outer periphery of the mode switching lever 43 and rising upward. Since the mode selection knob 73 rises upward, the upper end of the mode selection knob 73 is substantially flush with the upper surface of the shutter button 41, as illustrated in FIG. 4C. Thus, as illustrated in FIG. 4A, when a finger of the user is placed on the shutter button 41, the mode selection knob 73 comes into contact with the cushion of the finger. The surface of the mode selection knob 73 is knurled.

The mode switching lever 43 is provided with a lever hole 74. The lever hole 74 communicates with the mounting hole 51 in the upper surface plate 40 and with a cover hole 75 in the cover plate 70. The pressing shaft 41b of the shutter button 41 and the connecting shafts 64 of the zoom lever 42 are inserted into the lever hole 74.

As described above, the mode switching lever 43 is supported by and between the upper surface plate 40 and the cover plate 70. The cover plate 70 is made of synthetic resin or the like and connected to the upper surface plate 40 by welding or the like. The cover plate 70 has the cover hole 75 and a plurality of side walls 76. The cover hole 75 communicates with the mounting hole 51 in the upper surface plate 40. The side walls 76 are vertically arranged around the cover hole 75 and support the mode switching lever 43. The cover hole 75 is smaller in diameter than the mode switching lever 43. The side walls 76 each are formed into an arc shape having a diameter substantially the same as that of the mode switching lever 43. The cover plate 70 is provided with a mounting portion 77 for mounting the mode switching lever 43 thereon. The mounting portion 77 is formed around the cover hole 75 and surrounded by the side walls 76.

The cover hole 75 has a notch 75a which allows the pressing piece 72 protruding from the lower surface of the mode switching lever 43 to face toward the switch plate 44. The notch 75a is formed according to the turning area of the pressing piece 72, which is turned together with the mode switching lever 43.

The zoom operation ring 63 is turnably fitted into the cover hole 75 from below. The pair of engaging pieces 68 on the lower surface of the zoom operation ring 63 is secured to the lower surface of the cover plate 70. The zoom operation ring 63 is connected to the connecting shafts 64 of the zoom lever 42 through the cover hole 75.

Each positioning member 80 to be engaged with one of the positioning notches 71 of the mode selection knob 73 is formed by bending a substantially rectangular metal sheet, which also serves as a ground. The positioning members 80 are formed according to the positions of the positioning notches 71. The positioning members 80 are positioned opposite each other with the mode switching lever 43 interposed therebetween. Both of the positioning members 80 are attached to the back surface of the upper surface plate 40 by being supported by and between the upper surface plate 40 and the cover plate 70. The positioning members 80 each have an arm portion 81 biased toward the mode switching lever 43 and a substantially V-shaped engaging portion 82 disengageably engaged with one of the positioning notches 71 of substantially V-shape.

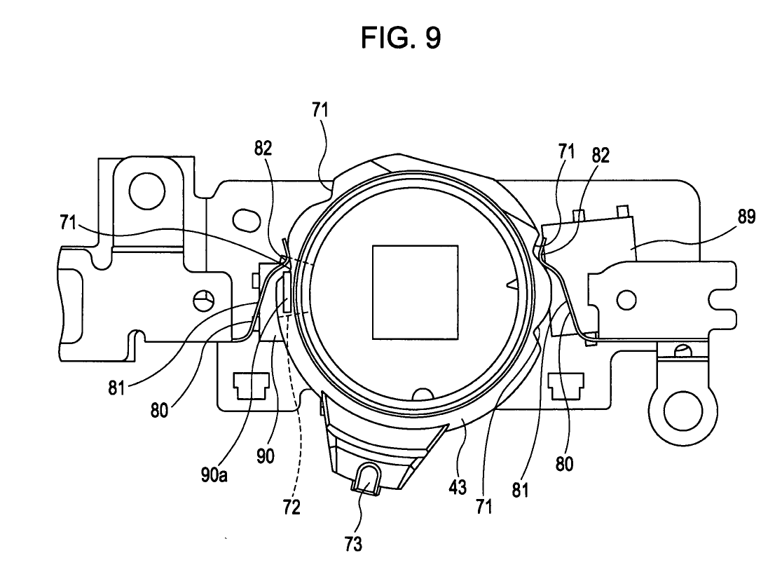

The engaging portion 82 of one of the positioning members 80 is engaged with one of the positioning notches 71 at a position (see FIG. 9) where the pressing piece 72 presses the mode selection switch 90 and at a position (see FIG. 8) where the pressing piece 72 is separated from the mode selection switch 90. Thus, since a click touch is given to the mode selection knob 73, it is possible to allow the user to sense that the mode switching lever 43 has been turned to a predetermined switching position and mode switching has taken place. The engaging portion 82 of each of the positioning members 80 is engaged with one of the positioning notches 71 by biasing force of the arm portion 81. This restricts turning of the mode switching lever 43. Therefore, the mode switching lever 43 is turned only when the user operates the mode selection knob 73.

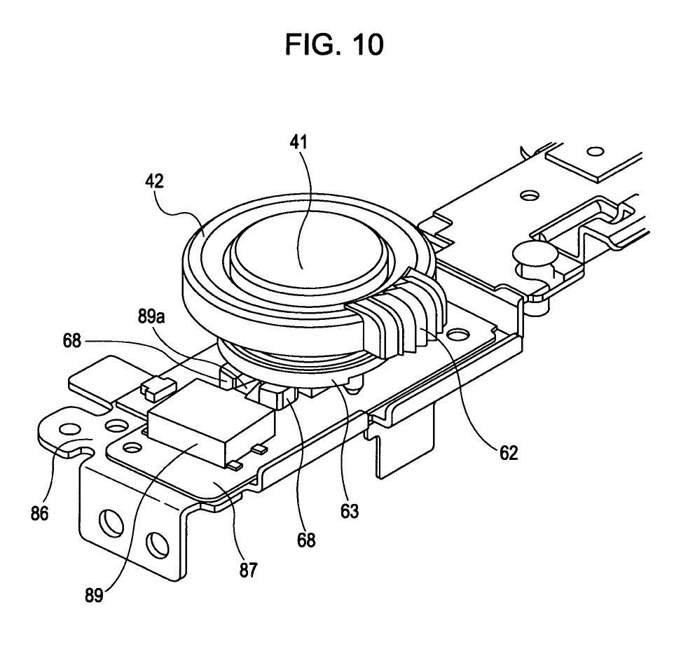

Next, the switch plate 44 on which various switches to be operated by the shutter button 41, the zoom lever 42, and the mode switching lever 43 are mounted will be described. As illustrated in FIG. 5 and FIG. 10, the switch plate 44 includes a rectangular metal plate 86; a flexible wiring board 87 affixed onto the metal plate 86; and the release switch 88, the zoom switch 89, and the mode selection switch 90 that are mounted onto the flexible wiring board 87.

The metal plate 86 is provided with a plurality of screw holes, and is secured to the back surface of the upper surface plate 40 by screws. Since the metal plate 86 is connected to a ground layer of the flexible wiring board 87, the metal plate 86 functions as a ground which eliminates static electricity etc. causing noise. The flexible wiring board 87 affixed onto the metal plate 86 includes a mounting portion on which the release switch 88, the zoom switch 89, and the mode selection switch 90 are mounted; and a wiring pattern which transmits output from each switch. The flexible wiring board 87 is connected to the control device 6 in the apparatus main body 2.

A so-called tactile switch is used as the release switch 88 facing the tip of the pressing shaft 41b. A so-called lever switch is used as the zoom switch 89 engaged with one of the engaging pieces 68 of the zoom operation ring 63. The zoom switch 89 is mounted on the flexible wiring board 87, with the switch piece 89a facing the zoom operation ring 63. A tactile switch from which the switch piece 90a protrudes upward is used as the mode selection switch 90 to be pressed by the pressing piece 72 of the mode switching lever 43.

When the shutter button 41 is pressed, the release switch 88 is pressed by the tip of the pressing shaft 41b. When the release switch 88 is pressed, the control device 6 captures a still image or a moving image depending on the selected mode.

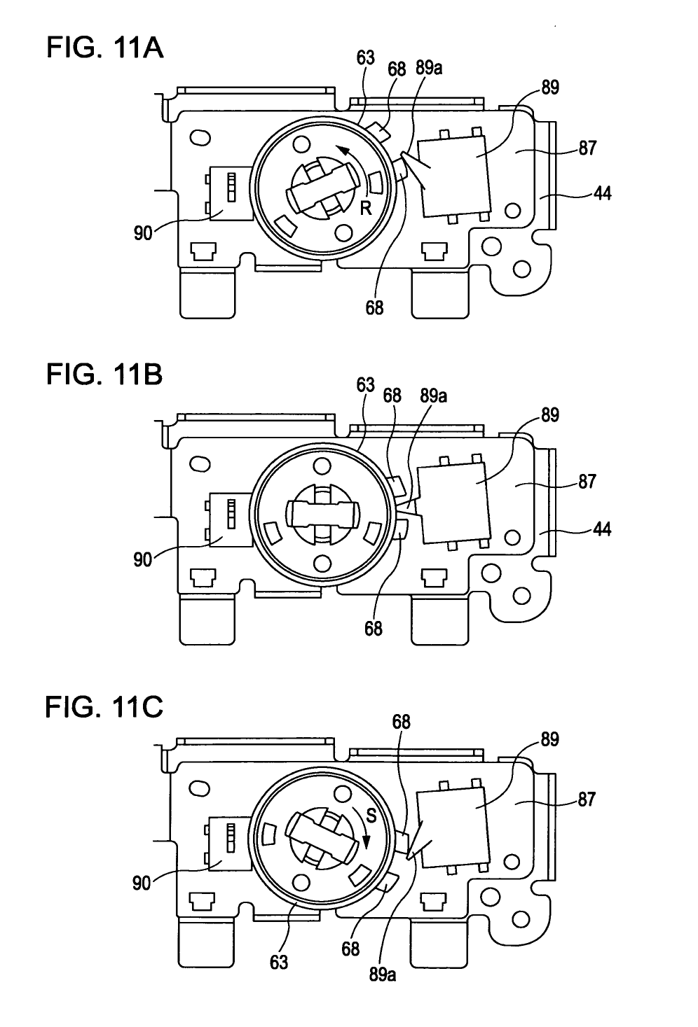

The zoom switch 89 is provided with the switch piece 89a that is supported at a neutral position and can be tilted in one or the other direction. As illustrated in FIG. 11A, when the zoom lever 42 and the zoom operation ring 63 are turned in the direction of arrow R, the switch piece 89a is tilted in one direction by one of the engaging pieces 68. As illustrated in FIG. 11B, when the zoom lever 42 is held at the neutral position by biasing force of the torsional coil spring 69, the switch piece 89a is brought out of contact with the engaging piece 68 and supported at the neutral position. As illustrated in FIG. 11C, when the zoom lever 42 and the zoom operation ring 63 are turned in the direction of arrow S, the switch piece 89a is tilted in the other direction by the other engaging piece 68. Depending on the direction in which the switch piece 89a is tilted, the control device 6 moves the zoom lens groups of the lens device 5 in the telephoto or wide-angle direction, or applies digital zoom processing to an image captured by the image pickup element 4.

The mode selection switch 90 is provided with the switch piece 90a vertically movably supported and continuously biased upward. When the mode switching lever 43 is turned to one switching position as illustrated in FIG. 9, the switch piece 90a is pressed by the pressing piece 72. When the mode switching lever 43 is turned to the other switching position as illustrated in FIG. 8, the switch piece 90a is released from the pressing piece 72. Depending on the pressed state of the switch piece 90a, the control device 6 changes the setting to the still-image pickup mode or the moving-image pickup mode.

In the image pickup apparatus 1 described above, the mode switching lever 43 is supported by and between the upper surface plate 40 and the cover plate 70. Thus, as illustrated in FIG. 1 and FIG. 3, the mode selection knob 73 protrudes to the rear side of the apparatus main body 2. The mode switching lever 43 is turned from the switching position on the right side 2a of the apparatus main body 2 to the switching position on a left side 2b of the apparatus main body 2. The image pickup apparatus 1 switches to a mode corresponding to each switching position of the mode switching lever 43. The mode switching lever 43 can be turned by operating the mode selection knob 73, for example, with the right thumb of the user holding the apparatus main body 2.

As illustrated in FIG. 4C, the upper end of the mode selection knob 73 is substantially flush with the upper surface of the shutter button 41. Therefore, when the mode selection knob 73 is turned to the switching position on the right side 2a of the apparatus main body 2 as illustrated in FIG. 4A, the mode selection knob 73 comes into contact with the cushion of an index finger placed on the pressed portion 41a of the shutter button 41. Thus, the image pickup apparatus 1 can allow the user to sense that the mode switching lever 43 is located at the switching position on the right side 2a of the apparatus main body 2. Therefore, when the switching position on the right side 2a is set to correspond to the moving-image pickup mode, the user trying to pick up still images can sense, without having to check the monitor or the like, that the apparatus main body 2 is in the moving-image pickup mode.

In the image pickup apparatus 1, the switching position on the right side 2a is set to correspond to the moving-image pickup mode and the switching position on the left side 2b is set to correspond to the still-image pickup mode. Thus, during still image pickup, the mode selection knob 73 is not in contact with the index finger of the user releasing the shutter, but is in contact with the index finger only during moving image pickup. Therefore, when the mode selection knob 73 is in contact with the index finger, the user can sense that the image pickup apparatus 1 is in the moving-image pickup mode, which is not the still-image pickup mode normally used.

As described above, the mode switching lever 43 is positioned in a manner biased toward the right side 2a of the apparatus main body 2. Typically, the operation of turning the mode switching lever 43 to the outside of the apparatus main body 2 is done according to the direction of a finger touching the mode switching lever 43 or the amount of force applied to the mode switching lever 43 by the finger. That is, this operation is typically done consciously by the user, but may not be done unconsciously or accidentally. Since the shutter button 41, the zoom lever 42, and the mode switching lever 43 are positioned in a manner biased toward the right side 2a of the apparatus main body 2, the image pickup apparatus 1 is operated with the right index finger or right thumb of the user holding the apparatus main body 2. During this operation, the right index finger or thumb extends inward from the outside of the apparatus main body 2. Human fingers are not unconsciously directed outward.

When the image pickup apparatus 1 is a digital still camera, the image pickup apparatus 1 is typically used to pick up still images, and is seldom used to pick up moving images. Therefore, if the user has to consciously select the moving-image pickup mode, an erroneous operation can be effectively prevented. Thus, the image pickup apparatus 1 is configured such that the moving-image pickup mode is entered when the mode switching lever 43 is turned to the right side 2a of the apparatus main body 2, and the still-image pickup mode is entered when the mode switching lever 43 is turned to the left side 2b of the apparatus main body 2. In the moving-image pickup mode, the shutter button 41 functions as an image pickup button. During moving image pickup, the mode selection knob 73 is continuously in contact with the cushion of the user's index finger, so that the user can sense that the image pickup apparatus 1 is in the moving-image pickup mode. On the other hand, in the still-image pickup mode, the mode selection knob 73 is not in contact with the cushion of the user's index finger, so that the user can perform still image pickup without having to be conscious of being in the still-image pickup mode.

Thus, the image pickup apparatus 1 can be prevented from being accidentally switched to the moving-image pickup mode. When the image pickup apparatus 1 is in the moving-image pickup mode, the mode selection knob 73 is in contact with the cushion of the user's index finger placed on the shutter button 41. This allows the user to directly sense the current mode setting without having to visually check the display panel 3 or the finder.

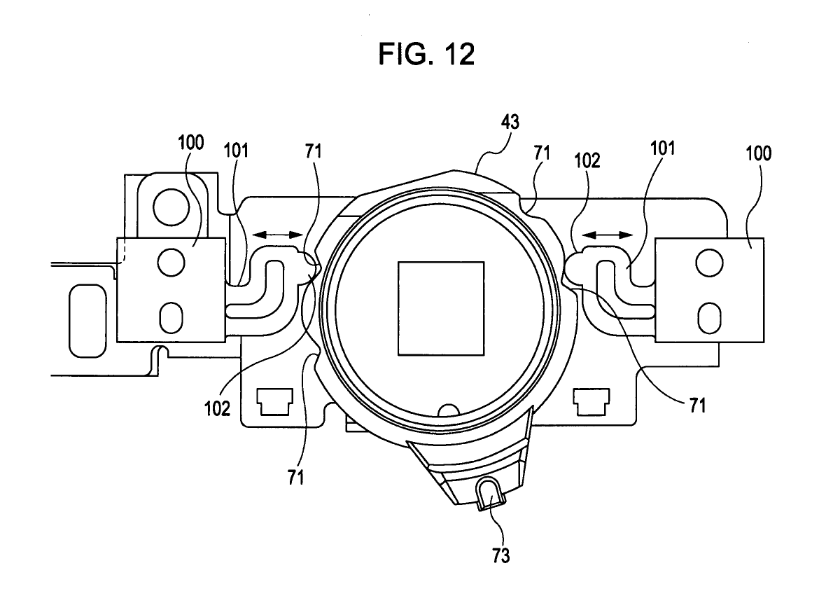

The positioning members 80, each having the arm portion 81 and the engaging portion 82, are formed by bending a metal sheet. Alternatively, such positioning members may be formed of engineering plastic, such as polyacetal (POM). Specifically, referring to FIG. 12, each of positioning members 100 is made of POM and formed into an arm portion 101 and an engaging portion 102 protruding from the tip of the arm portion 101. The arm portion 101 of each of the positioning members 100 is flexible and is biased toward the mode switching lever 43.

When the mode switching lever 43 is turned, a biasing force of the arm portion 101 of the positioning member 100 causes the engaging portion 102 to slide along the outer periphery of the mode switching lever 43, and to engage with a positioning notch 71 at a predetermined switching position. Since the engaging portion 102 is engaged with the positioning notch 71 by the biasing force of the arm portion 101, turning of the mode switching lever 43 is restricted. Thus, the mode switching lever 43 is turned only when the user operates the mode selection knob 73.

When the positioning members are made of engineering plastic, since variations in biasing force can be reduced, stable determination of switching positions and stable restriction on turning of the mode switching lever 43 can be ensured, as compared to the case where the positioning members are formed of a metal sheet.

In the foregoing description, switching between the moving-image pickup mode and the still-image pickup mode is done with the mode switching lever 43. Alternatively, switching between the still-image pickup mode and the playback mode, switching between ON and OFF of a flash function, or switching between ON and OFF of the main power of the apparatus main body 2 may be done with the mode switching lever 43.

Switching among three or more different modes may be done with the mode switching lever 43. In this case, the mode switching lever 43 is provided with three or more positioning notches 71, and a multistage switch is used as the mode selection switch 90. Thus, various modes, such as the still-image pickup mode, moving-image pickup mode, playback mode, and setting screen display mode, can be made selectable.

The image pickup apparatus to which the present invention is applied has been described above. The present invention is applicable not only to digital still cameras, film cameras, video cameras, etc., but also to a wide variety of electronic devices including mobile phones with a camera function, personal digital assistants (PDAs), portable audio and video players, and portable game machines.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup apparatus comprising:
an operation button; and
an operation member turnably mounted around the operation button, having an operation portion, and configured to allow a user to select a plurality of operation states by turning the operation portion,
wherein the operation portion is formed such that a user's finger placed on the operation button comes into contact with the operation portion at one or more positions to which the operation portion is turned.

2. The image pickup apparatus according to claim 1, wherein an upper surface of the operation button is substantially flush with an upper end of the operation portion.

3. The image pickup apparatus according to claim 1, further comprising a zoom lever mounted turnably on and concentrically with the operation member.

4. The image pickup apparatus according to claim 1, wherein the operation member is positioned in a manner biased toward one side of a main body of the image pickup apparatus, and a moving-image pickup mode is entered when the operation member is turned to the outside of the one side.

5. The image pickup apparatus according to claim 4, wherein a still-image pickup mode is entered when the operation member is turned to the inside of the one side.

6. The image pickup apparatus according to claim 5, wherein the image pickup apparatus is a film camera or a digital still camera.
